(19) United States
(12) Patent Application Publication
(10) Pub. No.: US 2010/0141653 A1
(43) Pub. Date: Jun. 10, 2010

(54) APPARATUS FOR PROVIDING AND TRANSFORMING SHADER OF 3D GRAPHIC SYSTEM

(75) Inventors: Jae-Ho Lee, Daejeon (KR); Joo-Haeng Lee, Daejeon (KR); Ho Wook Jang, Daejeon (KR); In Ho Lee, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejon (KR)

(21) Appl. No.: 12/517,066

(22) PCT Filed: Nov. 26, 2007
(86) PCT No.: PCT/KR2007/005984

§ 371 Date: Jan. 29, 2010

(30) Foreign Application Priority Data
Dec. 2, 2006 (KR) 10-2007-0121093
Sep. 28, 2007 (KR) 10-2007-0098056

(51) Int. Cl. G06T 15/60

(52) U.S. Cl. 345/426

(57) ABSTRACT

Provided are an apparatus and method for providing and transforming a shader of a 3-D graphic system. The apparatus for providing a shader of a 3-D graphic system includes a shader expressing unit for rendering a target shader, an option controller for controlling options of the shader, a similar shader generator for automatically generating similar shaders corresponding to the controlled options, and an output unit for outputting the automatically generated similar shaders.

### TECHNICAL FIELD

The present invention relates to a technology for performing a shader which generally takes long time and lots of efforts for rendering 3-D graphic data, and more particularly, to an apparatus and method for providing and transforming a shader of a 3-D graphic system, which analyze the characteristics of each shader for effectively rendering 3-D graphic data, generate meta data using the analyzing result for the convenience of a user, enable a user to intuitively generate and transform a shader by developing an easy user interface, and improves user's convenience through technically supporting a shader process which requires long time and lots of efforts for rendering 3-D graphic data by providing a solution of disparity of expressing results of shaders in systems.

The present invention is derived from a study conducted as a part of an Information Technology (IT) new growth engine core technology development project of the Ministry of Information and Communication, Republic of Korea (Project No. 2006-S-045-01, Title: Function expandable high speed rendering technology).

### BACKGROUND ART

Rendering is a process for adding reality to computer graphics by applying 3-D texture on the computer graphics, such as shades, color variation, and depth variation.

A real-time 3-D graphic technology has been rapidly advanced due to the improvement and the popularization of graphic hardware. That is, the improvement of graphic hardware allows the graphic hardware to perform related operations which were used to be performed by a central processing unit (CPU), thereby improving the performance thereof and enabling the CPU to concentrate other operations excepting the graphic related operations.

A shader is a computer program for adding a relation between an object and light. The shader gives various effects on 3-D graphics according to a user's intention. Therefore, realistic graphic images can be provided to a user through texture acceleration by activating the options of a shader.

In other words, a shader is a descriptor applied to each object of graphic data. The shader processes light reflection and light transmission according to the texture and the characteristics of an object. The shader is defined by combinations of various options.

In order to produce a shader that provides a desired result, it is required to conceptually understand and to numerically operate various options thereof. Such an approach gives difficulties to a graphic designer. That is, such an approach makes a real object to be seen differently and makes a designer not to reflect creative ideas on the computer graphics.

Also, a user is required to manually control each of the options of a desired shader and to revise the result of controlling the options by rendering the result. Therefore, it takes long time, and the reliability for the approach can be deteriorated, thereby degrading the efficiency of the rendering process.

Furthermore, since the options of a shader are differently defined in systems, it is impossible to produce the same result although the same shaders are used. Therefore, it is difficult to re-perform a previously performed operation again and to unify a process with another processes produced from another system.

### DISCLOSURE OF INVENTION

### Technical Problem

Accordingly, the present invention is directed to an apparatus and method for providing and transforming a shader of a 3-D graphic system, which substantially obviates one or more problems due to limitations and disadvantages of the related art.

It is an object of the present invention to provide an apparatus for providing a shader of a 3-D graphic system, which enables a user to easily access the options of a shader through familiar text formation by generating meta data for each of options of a shader and providing a convenient graphic interface to control options of each shader, enables a user to instantly confirm a result of controlling options, and enables a user to easily transform a shader based on the result of the controlling options.

It is another object of the present invention to provide an apparatus for transforming a shader of a 3-D graphic system, which transform a shader in systems by directly comparing shaders produced from different systems through applying visual descriptors that compare the characteristics of shaders and automatically revising the operations thereof.

In the present embodiment, a shader can be revised, searched, and transformed through generating meta data for each shader, technically accessing the options of shaders using an analyzing mechanism, and generating and applying visual descriptors for comparing results.

### Technical Solution

To achieve these objects and other advantages and in accordance with the purpose of the invention, as embodied and broadly described herein, there is provided an apparatus for providing a shader of a 3-D graphic system, including: a shader expressing unit for rendering a target shader; an option controller for controlling options of the shader; a similar shader generator for automatically generating similar shaders corresponding to the controlled options; and an output unit for outputting the automatically generated similar shaders.

The apparatus may further include: a meta data generator for analyzing options of the shader and generating meta data corresponding to the analyzed options; and a shader searching unit for searching a shader using the generated meta data information from the meta data generator and outputting the searching result through the output unit.

The option controller may automatically express options of a shader selected by a user.

The apparatus may further include a similarity comparator for analyzing similarity among the automatically generated similar shaders.

In another aspect of the present invention, there is provided an apparatus for transforming shaders produced by different 3-D graphic systems, including: a shader comparator for comparing options of a source shader and options of a target shader, which are inputted in a rendering process, and analyzing differences of the compared options; a shader transformer for transforming the target shader based on the differences of the options, which are obtained from the shader comparator; and an output unit for outputting the transformed target shader.

The shader comparator may use meta data generated through analyzing options of each shader to compare and analyze the differences of the options.

As described above, a user is enabled to freely revise, search, and transform a shader through analyzing a shader applied to render 3-D graphic data in the present invention. Therefore, a user can effectively and easily perform a shader process, which took long time and lots of effort for rendering 3-D graphic in the conventional apparatus and method, thereby effectively rendering the 3-D graphic data.

According to the present invention, a time and efforts required for revising and generating a shader for rendering 3-D graphic data can be reduced in order to enable a user to quickly and effectively perform a rendering operation and to apply creative ideas to the 3-D graphic data.

### Advantageous Effects

The apparatus and method for providing and transforming a shader according to the present invention enable a user to easily and effectively generate and revise a shader for rendering 3-D graphic data. Therefore, a user can quickly perform a rendering operation and conveniently generate and revise a target shader. Also, the apparatus and method for providing and transforming a shader according to the present invention can be applied to a 3-D graphic data rendering interface.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating an apparatus for providing a shader of a 3-D graphic system according to an embodiment of the present invention;

FIG. 2 is a diagram illustrating an example of embodying an apparatus for providing a shader of a 3-D graphic system;

FIG. 3 is a diagram illustrating the generation and application of meta data according to an embodiment of the present invention; and

FIG. 4 is a diagram illustrating an apparatus for transforming a shader of a 3-D graphic system, which transform shaders produced by different 3-D graphic systems according to an embodiment of the present invention.

### BEST MODE FOR CARRYING OUT THE INVENTION

Reference will now be made in detail to the preferred embodiments of the present invention, examples of which are illustrated in the accompanying drawings.

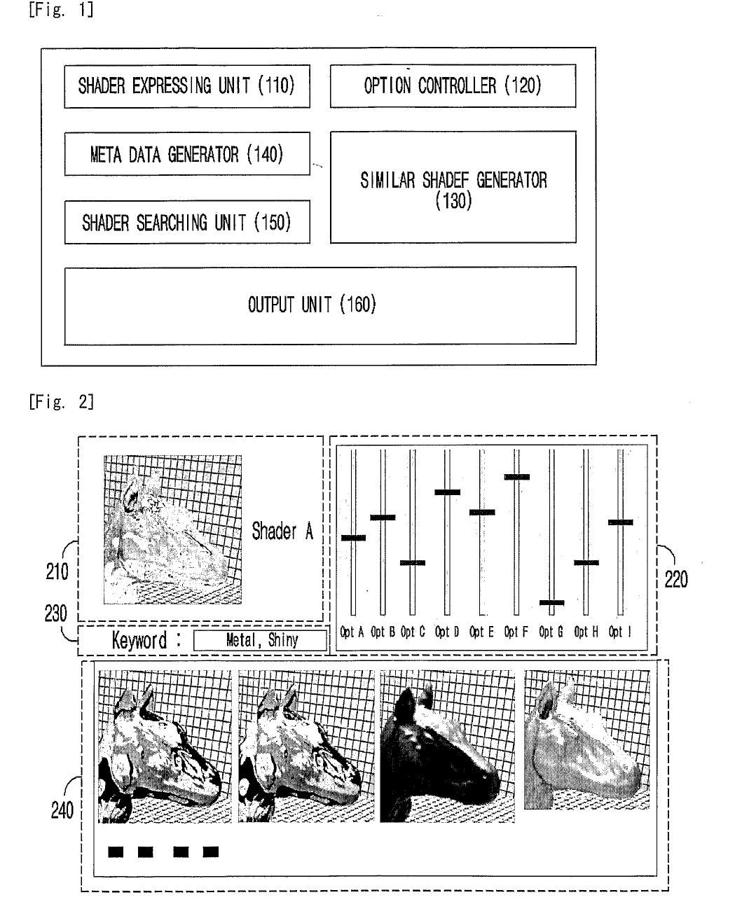

FIG. 1 is a block diagram illustrating an apparatus for providing a shader of a 3-D graphic system according to an embodiment of the present invention.

As shown in FIG. 1, the apparatus for providing a shader according to the present embodiment includes a shader expressing unit 110, an option controller 120, a similar shader generator 130, a meta data generator 140, a shader searching unit 150, and an output unit 160.

The shader expressing unit 110 expresses a predetermined shader through rendering.

The option controller 120 controls the options of a shader in order to automatically express the options of a shader selected by a user. The options can be simply controlled by a user. The controlling result is instantly applied to the shader expressed by the shader expressing unit 110.

Although a conventional option controller was applied to all of commercial systems, the result of controlling options was not instantly applied to an expressed shader. On the contrary, the option controller 120 according to the present embodiment instantly applies the option controlling result to the shader.

The option controller 120 also automatically provides a desired shader although a user does not control the options.

The similar shader generator 130 automatically generates similar shaders corresponding to the options controlled by the option controller 120. Similarly, if a user controls options, similar shaders may be automatically generated corresponding to the controlled options.

The meta data generator 140 analyzes options for a shader and generates meta data information corresponding to the analyzed option.

The shader searching unit 150 searches a shader using the generated meta data from the meta data generator 140 and outputs the result through the output unit 160.

The output unit 160 outputs the automatically-generated similar shaders or the searching result from the shader searching unit 150.

FIG. 2 is a diagram illustrating an example of embodying an apparatus for providing a shader applied when 3-D graph data is rendered.

Referring to FIG. 2, a shader expressing unit 210 is arranged at an upper left corner of a screen for rendering a shader, and the option controller 220 is arranged at an upper right corner of a screen to enable a user to intuitively control each of the options of the shader.

That is, the shader expressing unit 210 displays the rendering result of the current shader in real time, and the option controller 220 enables a user to easily control the options for the displayed shader.

The shader searching unit 230 is arranged under the shader expressing unit 210 in order to enable a user to easily search a shader through meta data.

The output unit 240 is arranged at the lower end of the screen. The output unit 240 displays similar shaders by automatically controlling the options of a shader rendered by the shader expression unit 210 or displays shaders searched based on the searching options by the shader search unit 230. The shader options may be automatically controlled by the similar shader generator 130, and the meta data for searching a shader may be provided by the meta data generator 140.

That is, the output unit 240 simultaneously displays the similar shaders, which are controlled by a user through the option controller 220, in order to increase the selectivity of a user. Also, the output unit 240 simultaneously displays results of searching shaders based on meta data through the shader searching unit 230 in order to improve the accessibility of a user.

Hereinafter, the operations of an apparatus for providing a shader of a 3-D graphic system will be described.

In first operation 1), if a user wants to generate a shader having metallicity, a user inputs a key word ‘metal’ into the shader searching unit 230. Then, the shader searching unit 230 displays searching results on the output unit 240. A user selects one of the displayed searching results on the output unit 240 or selects a basic metal shader. The selected shader is displayed on the shader expression unit 210.

In second operation 2), the option controller 220 automatically displays options of the selected shader. The displayed options can be simply controlled by a user, and the controlling results are instantly applied to the shader displayed in the shader expressing unit 210.

In third operation 3), similar shaders are searched based on a feature visual descriptor such as meta data of the shader displayed on the shader expression unit 210, the searched similar shaders are compared with another similar shaders generated by finely controlling the options of the selected shader. Then, the output unit 240 calculates the level of similarity thereof and arranges the similar shaders according to the calculated similarity level.

In fourth operation 4), the arranged shaders in the output units 240 can be selected by a user. In order to select one of the shaders, the operations 2 and 3 are repeatedly performed.

As described above, a user can generate a desired shader by controlling options using the option controller 220, or a user can intuitively select one of the shaders displayed on the output unit 240 as searching results.

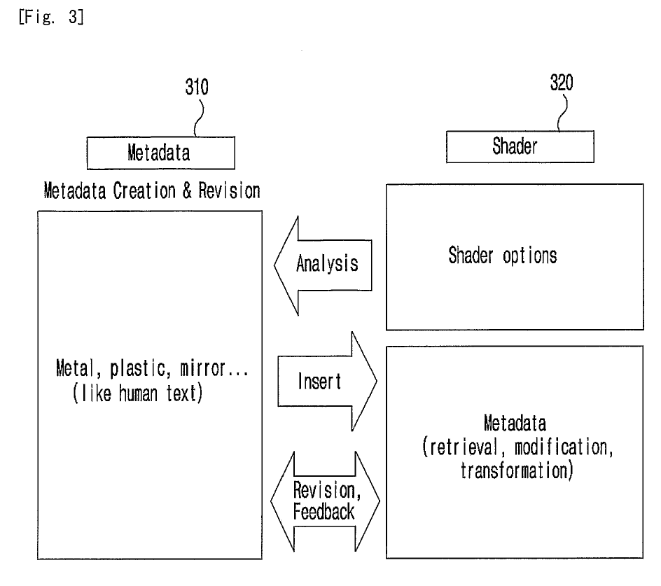

FIG. 3 is a diagram illustrating the generation and application of meta data according to an embodiment of the present invention.

Referring to FIG. 3, the meta data 310 can be generated by analyzing options of the shader 320. A user is enabled to easily search a desired shader by generating the meta data for the shader 320, applying the generated meta data, and feeding back the applying result according to the present embodiment. Therefore, accessibility can be expanded according to the present embodiment.

In the present embodiment, the meta data is referred as a feature visual descriptor because a user makes a decision based on visual sense.

In general, a shader may have several hundred options because the options are formed in a network structure.

For example, a metal shader includes options (parameters) such as color, ambient color, transparency, diffuse, specular, glossy, roughness, reflection, refraction, and reflected color. One of the options may include a plurality of sub-options.

Such a network structure of options can be differently set according to types of metal such as gold, silver, and copper. Also, a predetermined shader, for example, a shader expressing gold, can be defined by controlling various options. Therefore, many modifications thereof may exist. In the present embodiment, a user is enabled to easily search a desired shader by analyzing the options of a shader and generating meta data information corresponding to the analyzed options.

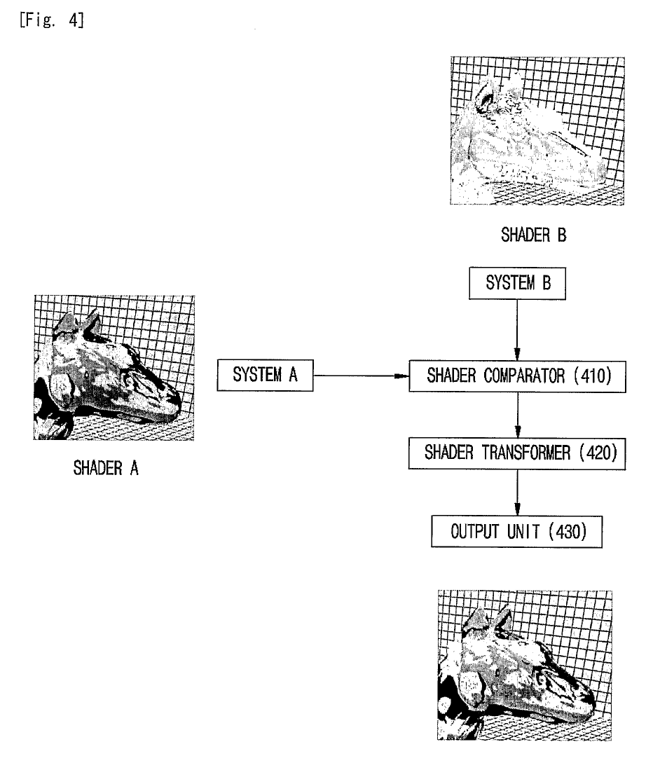

FIG. 4 is a diagram illustrating an apparatus for transforming a shader in a 3-D graphic system according to an embodiment of the present invention. The shader transforming apparatus according to the present embodiment may be one of examples to solve the disparity of shaders generated by different systems. In the present embodiment, a shader is automatically transformed by automatically controlling the options of a shader and analyzing the similarity of feature visual descriptors (meta data) of the generating results.

Referring to FIG. 4, the apparatus for transforming a shader according to the present embodiment includes a shader comparator 410, a shader transformer 420, and an output unit 430. The shader transforming apparatus according to the present embodiment controls options for a shader to have the same feeling by tracking data correlation of different systems by analyzing database.

The shader comparator 410 compares the options of a source shader A with the options of a target shader B, which are inputted in a rendering process, and analyzes the differences of the options. The differences of the options of the source shader A and the target shader B can be obtained using feature visual descriptors, that is, meta data. As described above, the meta data can be generated by analyzing the options of a shader.

Similarly, the shader transforming apparatus according to the present embodiment may further include a similarity comparator for analyzing similarity among automatically-generated similar shaders in order to determine the similarity among shaders in the same program.

The shader transformer 420 transforms the target shader B by automatically controlling the options of the target shader B based on the obtained option differences from the shader comparator 410.

That is, the shader transformer 420 enables a user to see the results after automatically and intuitively controlling the options. The user can instantly confirm the results without controlling the options manually.

Finally, the output unit 430 outputs the transformed target shader.

For example, although a user creates a computer graphic of 24K gold, the created computer graphic may not have the same feel according to the characteristics of systems and programs. It is a good example of the disparity of shaders.

That is, the created computer graphic may be too dark in a program, or the created computer graphic may be seen as 14K gold in another program. It happens because programs use different function and parameter values for rendering. The shader transforming apparatus according to the present embodiment controls the options (parameters) of a shader for the shader to have the same feeling corresponding to the values processed for 24K gold.

As described above, the apparatus and method for providing and transforming a shader according to the present invention according to the present invention enable a user to easily and effectively generate and revise a shader for rendering 3-D graphic data. Therefore, a user can quickly perform a rendering operation and conveniently generate and revise a target shader. Also, the apparatus and method for providing and transforming a shader according to the present invention can be applied to a 3-D graphic data rendering interface.

It will be apparent to those skilled in the art that various modifications and variations can be made in the present invention. Thus, it is intended that the present invention covers the modifications and variations of this invention provided they come within the scope of the appended claims and their equivalents.

1. An apparatus for providing a shader of a 3-D graphic system, comprising:
a shader expressing unit for rendering a target shader;
an option controller for controlling options of the shader;
a similar shader generator for automatically generating similar shaders corresponding to the controlled options; and
an output unit for outputting the automatically generated similar shaders.

2. The apparatus of claim 1, further comprising:
a meta data generator for analyzing options of the shader and generating meta data corresponding to the analyzed options; and
a shader searching unit for searching a shader using the generated meta data information from the meta data generator and outputting the searching result through the output unit.

3. The apparatus of claim 1, wherein the option controller automatically expresses options of a shader selected by a user.

4. The apparatus of claim 1, further comprising a similarity comparator for analyzing similarity among the automatically generated similar shaders.

5. An apparatus for transforming shaders produced by different 3-D graphic systems, comprising:
a shader comparator for comparing options of a source shader and options of a target shader, which are inputted in a rendering process, and analyzing differences of the compared options;
a shader transformer for transforming the target shader based on the differences of the options, which are obtained from the shader comparator; and
an output unit for outputting the transformed target shader.

6. The apparatus of claim 5, wherein the shader comparator uses meta data generated through analyzing options of each shader to compare and analyze the differences of the options.
